(19) United States
(12) Patent Application Publication
(10) Pub. No.: US 2002/0073620 A1
(43) Pub. Date: Jun. 20, 2002

(54) Sports equipment assembly

(76) Inventor: Patricia Rozanne Lank, Lewiston, NY (US)

Correspondence Address: Richard D. Fuerle, 1711 West River Road, Grand Island, NY, 14072, US

(21) Appl. No.: 09/738,300

(22) Filed: Dec. 15, 2000

(51) Int. Cl. E06B 7/00

(52) U.S. Cl. 49/70; 160/188; 49/197

(57) ABSTRACT

A sports equipment assembly is disclosed. The assembly comprises a garage door, various types of sports equipment, and means for mounting the sports equipment to the door.

### BACKGROUND OF THE INVENTION

This invention relates to a garage door to which can be attached various types of sports equipment. In particular, it relates to a rubber-coated steel garage door to which can be attached hoops, targets, lines, nets, or other types of sports equipment.

Children frequently play tennis, soccer, and other games in driveways, using a garage door as a backboard. Repeatedly striking a garage door with hockey pucks, balls, or other objects can, of course, result in dents, chipped paint, and other damage to the door. The haphazard attachment of hoops or other equipment to the door can also damage it and equipment attached in this way can fall off during use. In addition, the garage door acts as a sounding board, magnifying the striking noise, which can annoy people in the vicinity.

### SUMMARY OF THE INVENTION

I have invented a sports equipment assembly which comprises a garage door, various sports equipment, and means for attaching the sports equipment to the door. The door can be made of rubber-coated steel so that it is not easily damaged from repeatedly being struck by pucks, balls, or other objects. The rubber coating also absorbs the sound, greatly reducing the noise level. The door is provided with any of several means for attaching the equipment to it, so that the equipment can be quickly and securely fastened to the door. The equipment can be easily removed from the door so that equipment used for different games can be attached.

### BRIEF DESCRIPTION OF THE DRAWINGS

FIG. 1 is an isometric view of a certain presently preferred embodiment of a garage door according to this invention without sports equipment attached thereon.

FIG. 2 is an is an isometric view of a garage door according to this invention with a horizontal line attached.

FIG. 3 is an isometric view of a garage door according to this invention with a horizontal line attached.

FIG. 4 is an isometric view of a garage door according to this invention with a target attached.

FIG. 5 is an isometric view of a garage door according to this invention with a soccer net attached.

FIG. 6 shows the detail circled in FIG. 1.

FIG. 7 shows the detail circled in FIG. 2.

FIG. 8 shows the detail circled in FIG. 5.

### DESCRIPTION OF THE PREFERRED EMBODIMENTS

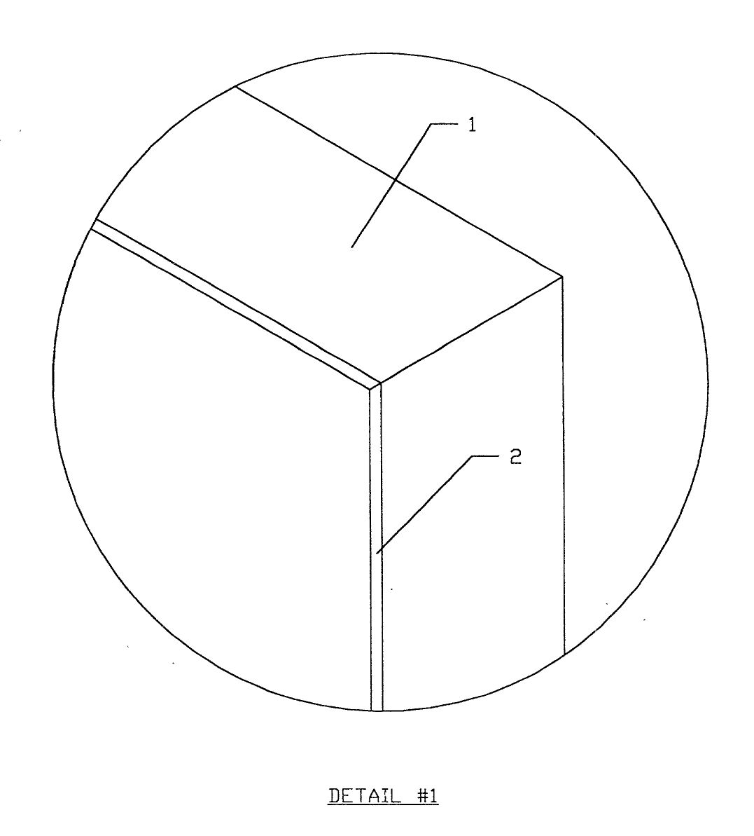

In the Figures, sports equipment assembly 1 is made up of garage door 2, attachment means 3, and sports equipment 4. Garage door 2 has multiple horizontal panels 5 joined together by hinges 6. Referring to FIG. 6, each panel 5 is made of steel 6 coated with an elastomer 7, such as a synthetic rubber, e.g., “Neoprene” (polychloroprene), polybutadiene, styrene-butadiene copolymer, nitrile rubber, polyurethane rubber, butyl rubber, polysulfide rubber, and polyisoprene, as it is tough, durable, and can be made in different colors and textures. The panels 5 could also be made of other materials such as plastic, aluminum, or wood, but steel is preferred as it is inexpensive and strong. The garage door can be single or double-size, overhead or sliding, single piece or panel, or another type, but double-size paneled overhead garage doors are preferred as they are common on residential housing.

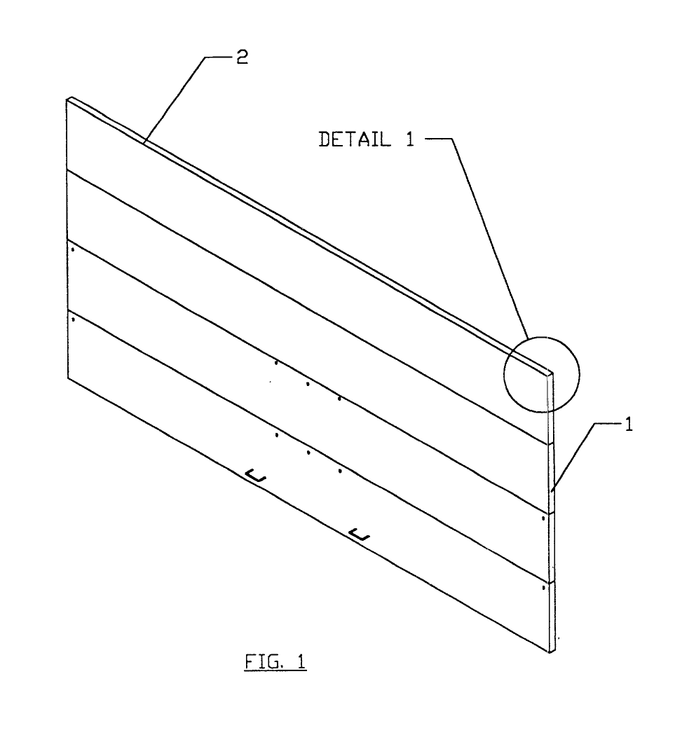

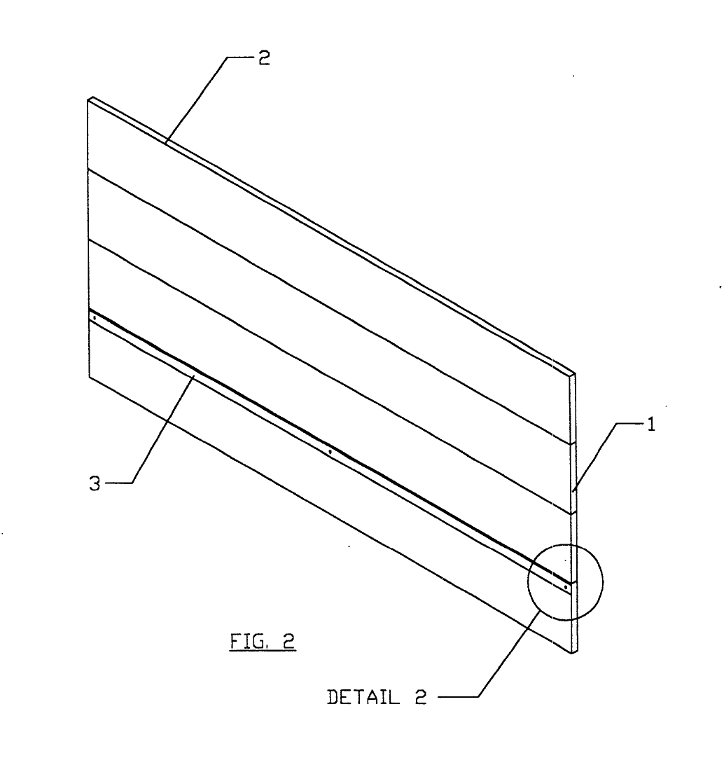

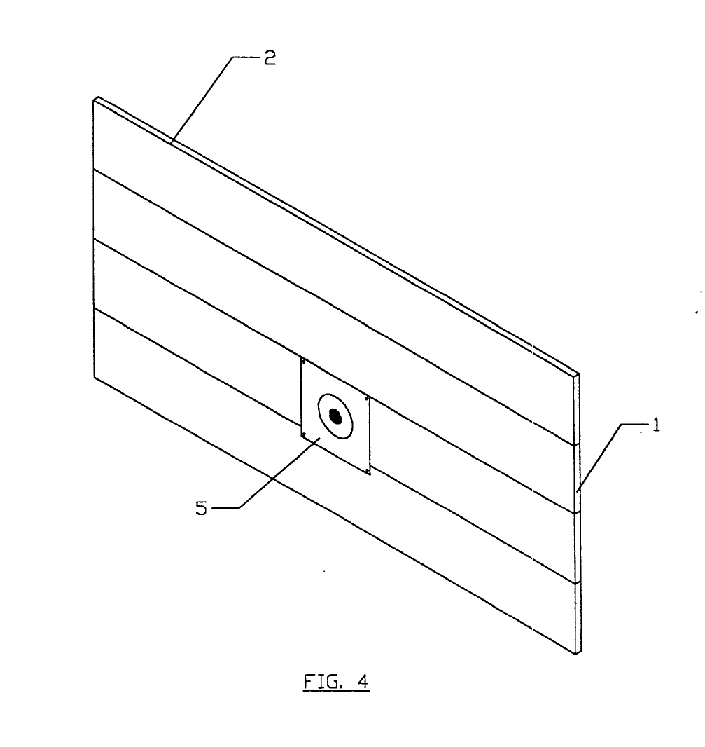

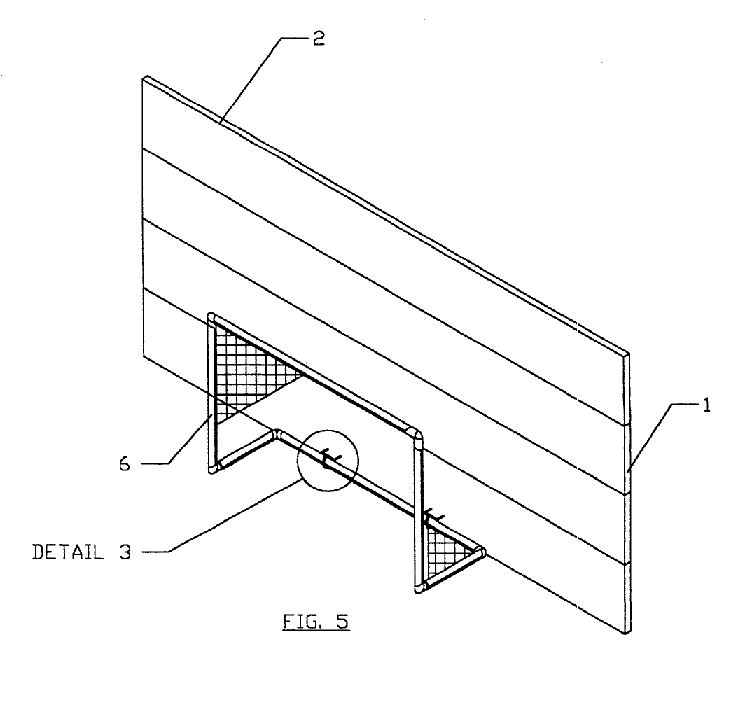

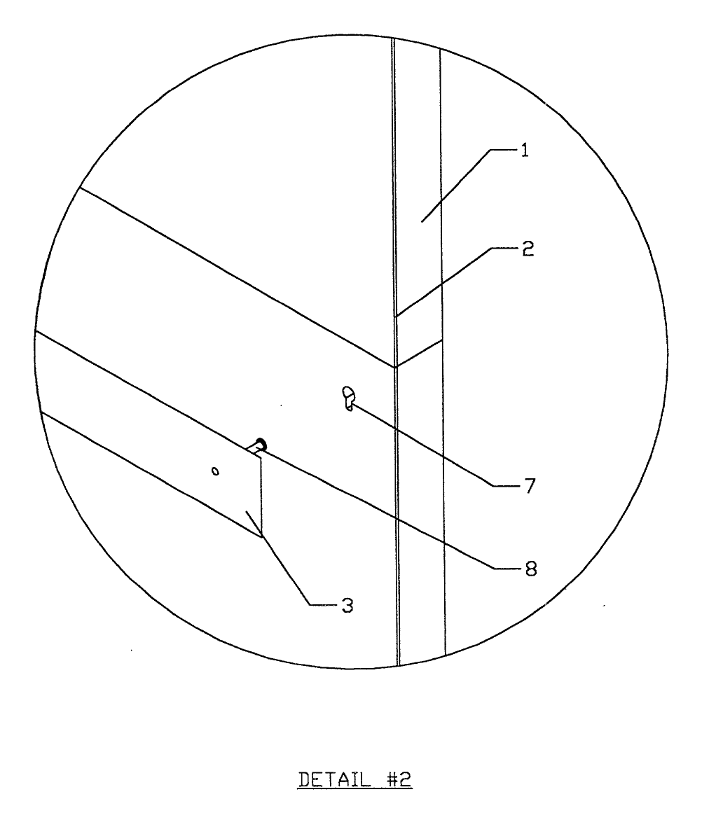

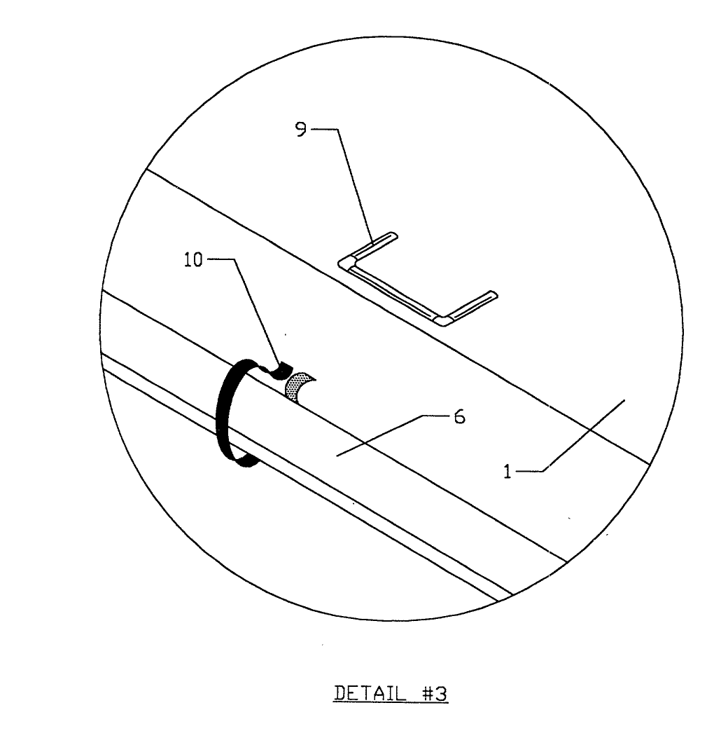

Sports equipment 4 can be attached to an exposed surface of garage door 2 by any suitable attachment means 8. Attachment means 8 should permit sports equipment 4 to be quickly, easily, and repeatedly attached and removed from door 2. Some examples of attachment means are illustrated in FIG. 1, which show holes 8 and U-shaped brackets 9. In FIGS. 2 and 7, hooked fabric 10, such as “Velcro,” is fastened to door 2 by forcing pinnails 11 into holes 8 so that a second fabric attached to line 12 can be releaseably held by those small fabric hooks. In FIG. 4, bull's eye target 13 can be attached to door 2 by pinnails or hooked fabric. In FIGS. 5 and 8, hooked fabric straps 14 hold net 15 to U-shaped brackets 9. Other attachment means include clips, bolts, screws, and releaseable adhesive. In order to preserve the appearance of the door when the sports equipment is not in use and permit the door to be opened and closed, the sports equipment must be removeable and should not be painted on, riveted on, or otherwise permanently attached to the door. Either the outside or the inside or both surfaces of door 2 can be modified with attachment means 8 to accept sports equipment 4, but preferably only the outside surface is modified. As shown in FIG. 1, door 2 can have several types of attachment means 8, each attachment means being appropriate for a different type of sports equipment, so that the same door can accept more than one type of sports equipment, preferably, it has at least 2 different types of attachment means 8 for attaching at least 2 different types of sports equipment.

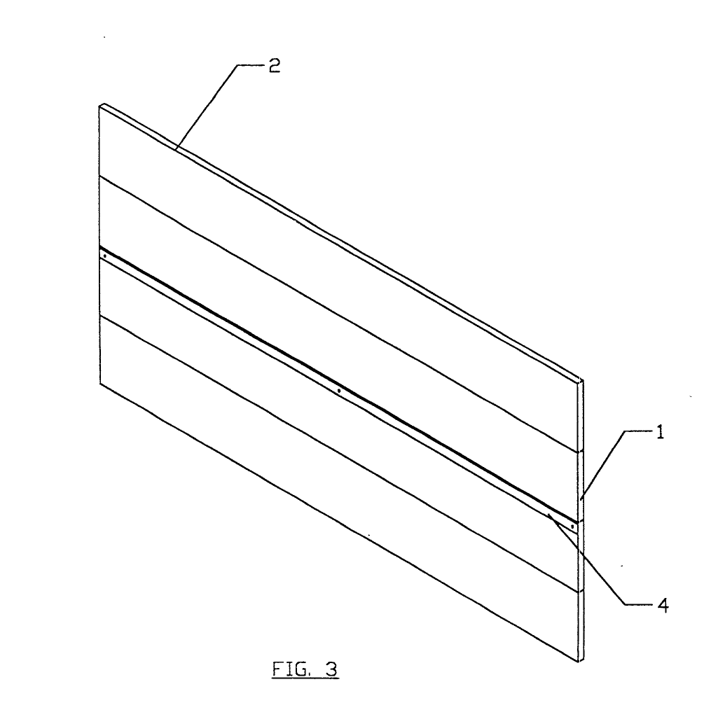

The term “sports equipment” is intended to include any object at which something can be thrown, hit, kicked, shot, or otherwise directed. FIGS. 2 and 3 show a horizontal line 12, which can be mounted in a low position (FIG. 2) for playing squash or in a higher position (FIG. 3) for playing tennis or racket ball. In FIG. 4, bull's eye target 13 can be used for playing darts or practicing archery or pellet shooting. In FIG. 5, a soccer net 15 can be used for playing soccer, hockey, or lacrosse. Other examples of sports equipment include vertical lines for playing squash and raquetball, horizontal hoops for playing basketball, vertical hoops for practicing throwing baseballs, footballs, or other objects, nets for catching hockey pucks, golf balls, or lacrosse balls, punching bags for boxing, kick boxing, or karate, and physical therapy equipment, such as pillows for strengthening arms or legs.

To use the sports equipment assembly of this invention, garage door 2 is closed, or at least partly closed, and the desired sports equipment 4 is attached to the door using the appropriate attachment means 3. To play a different game, sports equipment 4 is simply unattached and the process is repeated with different sports equipment.

We claim:

1. A sports equipment assembly comprising
(A) a garage door;
(B) sports equipment; and
(C) means for removeably attaching said sports equipment to at least one exposed surface of said garage door.

2. An assembly according to claim 1 wherein said garage door is a double garage door.

3. An assembly according to claim 1 wherein said garage door comprises multiple horizontal panels hinged together.

4. An assembly according to claim 1 wherein said garage door is an overhead door.

5. An assembly according to claim 1 wherein said garage door is coated with an elastomer.

6. An assembly according to claim 5 wherein said elastomer is polyurethane.

7. An assembly according to claim 1 wherein said garage door is; made of steel coated with a synthetic rubber.

8. An assembly according to claim 1 wherein said sports equipment is a horizontally-mounted hoop.

9. An assembly according to claim 1 wherein said sports equipment is a vertically-mounted hoop.

10. An assembly according to claim 1 wherein said sports equipment is a horizontal line.

11. An assembly according to claim 1 wherein said sports equipment is a vertical line.

12. An assembly according to claim 1 wherein said sports equipment is a target.

13. An assembly according to claim 12 wherein said target is a bull's eye.

14. An assembly according to claim 1 wherein said sports equipment is a net.

15 An assembly according to claim 1 wherein said means is screws.

16. An assembly according to claim 1 wherein said means are U-shaped brackets through which passes hooked fabric straps.

17. An assembly according to claim 1 wherein said means is a hooked fabric and a second fabric releaseably held by said hooks.

18. A sports equipment assembly comprising
(A) an elastomer-coated double-size paneled garage door;
(B) sports equipment selected from the group consisting of a net, a horizontal hoop, a vertical hoop, a target, a horizontal line, a vertical line, and mixtures thereof; and
(C) at least two means for removeably attaching said sports equipment to the outside of said garage door.

19. A sports equipment assembly comprising
(A) an elastomer-coated double-sized steel garage door which comprises multiple horizontal panels hinged together;
(B) sports equipment selected from the group consisting of a horizontal hoop, a vertical hoop, a target, a horizontal line, a vertical line, and mixtures thereof; and
(C) at least 2 means for removeably attaching said sports equipment to the outside surface of said garage door selected from the group consisting of hooked fabric, clips, bolts, screws, and pinnails.

20. An assembly according to claim 19 wherein said elastomer is a synthetic rubber.
